(19) United States
(12) Patent Application Publication
(10) Pub. No.: US 2009/0302024 A1
(43) Pub. Date: Dec. 10, 2009

(54) Heat Processing Method and Heat Processing Apparatus

(76) Inventor: Yasushi Aiba, Yamanashi-Ken (JP)

Correspondence Address: SMITH, GAMBRELL & RUSSELL, 1130 CONNECTICUT AVENUE, N.W., SUITE 1130, WASHINGTON, DC, 20036, US

(21) Appl. No.: 12/085,668

(22) PCT Filed: Nov. 28, 2006
(86) PCT No.: PCT/JP2006/323704

§ 371 Date: May 29, 2008

(30) Foreign Application Priority Data
Nov. 29, 2005 (JP) 2005-344642

(51) Int. Cl. F27B 5/16; H05B 3/68; G05D 7/00

(52) U.S. Cl. 219/390; 219/444.1; 700/282

(57) ABSTRACT

The present invention is a heat processing method comprising: a placement step in which an object to be processed is placed on a stage disposed in a processing vessel whose inside atmosphere is capable of being discharged; and a heat processing step that is performed after the placement step, in which a temperature of the object to be processed is elevated to a predetermined set temperature and is maintained thereat by a heating unit that is activated by a power supply, and in which a predetermined gas is caused to flow into the processing vessel so as to perform a predetermined heat process to the object to be processed; wherein, immediately before the heat processing step, there is performed at least once a brief large-power supply step, in which a power larger than that to be supplied to the heating unit for maintaining the temperature of the object to be processed in the heat processing step is briefly supplied to the heating unit.

### FIELD OF THE INVENTION

The present invention relates to a heat processing method and a heat processing apparatus for performing a predetermined heat process, such as a film deposition process, to an object to be processed, such as a semiconductor wafer.

### BACKGROUND ART

When a semiconductor integrated circuit is manufactured, various heat processes, such as a film deposition process, an oxidation and diffusion process, an annealing process, and a modification process, and an etching process are generally repeatedly performed to an object to be processed, such as a semiconductor wafer, so as to form a desired integrated circuit.

Given herein as an example of the heat process is a case where a metal thin film, such as a thin film of tungsten (W), is formed. FIG. 12 shows a general processing apparatus for a film deposition, which forms such a metal thin film. In a processing vessel 102 that is formed of, e.g., aluminum into a tubular shape, there is disposed a stage 104 formed of, e.g., a thin carbon material or an aluminum compound. Located below the stage 104 via a quartz transmission window 106 is a heating unit 108 consisting of a heating lamp such as a halogen lamp (JP2003-96567A). There is another case in which a resistance heater as the heating unit is provided in the stage itself, in place of the heating lamp (JP2004-193396).

Heat rays from the heating unit 108 pass through the transmission window 106 and reach the stage 104. Thus, the stage 104 is heated, and a semiconductor wafer W placed on the stage 104 is indirectly heated to a predetermined temperature and maintained thereat. Simultaneously therewith, WF₆ and SiH₄, for example, as a process gas is uniformly supplied onto a surface of the wafer from a showerhead 110 located above the stage 104. Thus, a metal film of W or WSi is formed on the wafer surface.

In this case, the metal film is deposited not only on the wafer surface as a target, but also on elements inside the processing vessel, i.e., members located near the wafer, such as an inner wall of the processing vessel, a surface of the showerhead, and a clamp ring, not shown. When peeled off, the deposition becomes particles, which causes deterioration in the yield of wafers. Thus, after each time when a predetermined number of wafers, e.g., 25 wafers have been processed, ClF₃, for example, as a corrosive cleaning gas, is caused to flow so as to remove an excessive deposition film of W or WSi adhering to the surfaces of the inside elements. In this case, since the cleaning gas generally has a higher reactivity, the temperature in the processing vessel is lowered to a temperature that is considerably lower than the temperature for the film deposition, in order to protect the inside elements against the cleaning gas. Under this state, the cleaning gas is caused to flow so as to perform the cleaning process.

As described above, by causing the cleaning gas to flow into the processing vessel so as to perform the cleaning process, the unnecessary deposition film on the surfaces of the inside elements of the processing vessel are removed. Due to the removal thereof, thermal conditions (change in radiant heat from the processing vessel, and change in radiant heat or reflection from the inside elements) inside the processing vessel after the cleaning process are greatly different from those inside the processing vessel before the cleaning process. Thus, if the film deposition process is performed to product-wafers immediately after the cleaning process, thicknesses of films formed on some wafers initially subjected to the film deposition process are not stable because the thermal conditions in the processing vessel are not stable. That is, reproducibility of a film thickness is inferior.

In order to avoid this situation, generally, the film deposition process is not performed to product-wafers immediately after the cleaning process. In place thereof, for example, by causing a film deposition gas to flow into the processing vessel without loading any wafer under the same conditions as the film deposition conditions, a thin film is deposited on the surfaces of the inside elements such as the showerhead and the stage on which a wafer can be placed (so-called precoating process). Thus, the thermal conditions in the processing vessel are made stable.

However, even when the precoating process is performed in the processing vessel as described above, there is actually a possibility that sufficient thermal stability cannot be achieved. In this case, film thicknesses on some wafers initially processed after the start of the film deposition process, are not sufficiently stable. Namely, the reproducibility of film thickness is still unsatisfactory. It can be proposed that the precoating process is performed a large number of times so as to secure the thermal stability in the processing vessel. However, since it takes for each precoating process about 10 minutes, the large number of times of the precoating process may decrease throughput.

### SUMMARY OF THE INVENTION

In view of the above disadvantages, the present invention has been made so as to effectively eliminate the same. The object of the present invention is to provide a heat processing method and a heat processing apparatus capable of maintaining an excellent reproducibility of a heat process, such as of a film thickness or the like in the film deposition process, without practically lowering throughput.

As a result of extensive studies of a reproducibility of a film thickness in a heat processing apparatus of a wafer-fed type, the inventor of the present invention have found that, by performing a brief heat cycle process to the inside of the processing vessel, the inside elements can be thermally stabilized so that the reproducibility of a heat process such as a film thickness can be improved. The present invention was made based on this finding.

The present invention is a heat processing method comprising: a placement step in which an object to be processed is placed on a stage disposed in a processing vessel whose inside atmosphere is capable of being discharged; and a heat processing step that is performed after the placement step, in which a temperature of the object to be processed is elevated to a predetermined set temperature and is maintained thereat by a heating unit that is activated by a power supply, and in which a predetermined gas is caused to flow into the processing vessel so as to perform a predetermined heat process to the object to be processed; wherein, immediately before the heat processing step, there is performed at least once a brief large-power supply step, in which a power larger than that to be supplied to the heating unit for maintaining the temperature of the object to be processed in the heat processing step is briefly supplied to the heating unit.

According to the present invention, by performing at least once the brief large-power supply step, the inside elements of the processing vessel can be thermally stabilized. Thus, an excellent reproducibility of a heat process, e.g., an excellent reproducibility of a film thickness in the film deposition step can be maintained, without practically lowering throughput.

For example, as a pre-step of the brief large-power supply step, there is performed a precoating step, in which the predetermined gas is caused to flow into the processing vessel in which the object to be processed has not been received, so as to perform a precoating process to an inside of the processing vessel.

In this case, for example, as a pre-step of the precoating step, there is performed a cleaning step, in which a cleaning gas is caused to flow into the processing vessel at a temperature lower than the predetermined set temperature.

In addition, for example, immediately before the brief large-power supply step, there is performed a power OFF step, in which a power to be supplied to the heating unit is temporarily turned off. Alternatively, also immediately before the brief large-power supply step, a power is supplied to the heating unit.

In addition, for example, when the brief large-power supply step is performed, a gas is supplied into the processing vessel.

In addition, preferably, the brief large-power supply step is intermittently performed at least three times.

In addition, for example, disposed near the stage is a clamp ring that is capable of being vertically moved in order that the clamp ring comes into contact with a peripheral portion of an object to be processed placed on the stage so as to fix the object to be processed onto the stage, and the clamp ring is utilized in the placement step.

In addition, for example, the heating unit is a heating lamp arranged below the stage.

In addition, for example, a power supplied in the brief large-power supply step corresponds to 100% of a rated power of the heating unit.

Further, the present invention is a heat processing apparatus comprising: a processing vessel whose inside atmosphere is capable of being discharged; a stage disposed in the processing vessel, for placing thereon an object to be processed; a gas introducing unit that introduces a predetermined gas into the processing vessel; a heating unit that is activated by a power supply so as to heat the object to be processed; and a control unit that controls the gas introducing unit and the power supply to the heating unit, so as to perform, to the object to be processed, a predetermined heat processing step in which a temperature of the object to be processed is elevated to a predetermined set temperature and is maintained thereat, and in which the predetermined gas is caused to flow into the processing vessel; wherein the control unit further controls the power supply to the heating unit, so as to perform, immediately before the heat processing step, at least once a brief large-power supply step in which a power larger than that to be supplied to the heating unit for maintaining the temperature of the object to be processed in the heat processing step is briefly supplied to the heating unit.

According to the present invention, by performing at least once the brief large-power supply step, the inside elements of the processing vessel can be thermally stabilized. Thus, an excellent reproducibility of a heat process, e.g., an excellent reproducibility of a film thickness in the film deposition step can be maintained, without practically lowering throughput.

In this case, for example, disposed near the stage is a clamp ring that is capable of being vertically moved in order that the clamp ring comes into contact with a peripheral portion of an object to be processed placed on the stage so as to fix the object to be processed onto the stage.

In addition, for example, the heating unit is a heating lamp arranged below the stage.

In addition, for example, a power supplied in the brief large-power supply step corresponds to 100% of a rated power of the heating unit.

Furthermore, the present invention is a control device that controls a heat processing apparatus comprising: a processing vessel whose inside atmosphere is capable of being discharged; a stage disposed in the processing vessel, for placing thereon an object to be processed; a gas introducing unit that introduces a predetermined gas into the processing vessel; and a heating unit that is activated by a power supply so as to heat the object to be processed; wherein the control device is configured to control the gas introducing unit and the power supply to the heating unit, so as to perform, to the object to be processed, a predetermined heat processing step in which a temperature of the object to be processed is elevated to a predetermined set temperature and is maintained thereat, and the control device is configured to further control the power supply to the heating unit, so as to perform, immediately before the heat processing step, at least once a brief large-power supply step in which a power larger than that to be supplied to the heating unit for maintaining the temperature of the object to be processed in the heat processing step is briefly supplied to the heating unit.

Alternatively, the present invention is a program to be read-out and executed by a computer so as to achieve the aforementioned control device, or a storage medium storing therein this program.

### BRIEF DESCRIPTION OF THE DRAWINGS

FIG. 1 is a schematic structural view showing an embodiment of a heat processing apparatus according to the present invention;

FIG. 2 is a flowchart showing an overall flow of a process performed by the heat processing apparatus shown in FIG. 1;

FIG. 3 is a flowchart showing details of an example of the precoating process shown in FIG. 2;

FIG. 4 is a flowchart showing details of a film deposition process of depositing a tungsten film, as an example of the film deposition process shown in FIG. 2;

FIG. 5 is a flowchart showing details of an example of the heat cycle process shown in FIG. 2;

FIG. 6 is a timing chart showing supply conditions of respective gases and a supply power to heating lamps, in the example of the heat cycle process shown in FIG. 5;

FIG. 7 is a graph showing a relationship between a power supplied to the heating lamps and a temperature of a stage, during the precoating process and the succeeding heat cycle process;

FIG. 8A is a graph showing temperature changes of a stage and a clamp ring when a conventional method was performed;

FIG. 8B is a graph showing temperature changes of a stage and a clamp ring when a method of the present invention was performed;

FIG. 9A is a graph showing a reproducibility (variation ratio) of a film thickness with respect to the number of times of the precoating process in the conventional method;

FIG. 9B is a graph showing a reproducibility (variation ratio) of a film thickness with respect to the number of times of a brief large-power supply step (the number of times of a heat cycle) in the method of the present invention;

FIG. 10A is a graph showing a reproducibility (variation ratio) of a film thickness when wafers were actually subjected to a conventional film deposition process;

FIG. 10B is a graph showing a reproducibility (variation ratio) of film thickness when wafers were actually subjected to a film deposition process of the present invention;

FIG. 11 is a flowchart showing details of another example of the heat cycle process; and

FIG. 12 is a schematic structural view showing a conventional film deposition apparatus that forms a metal thin film.

### BEST MODE FOR CARRYING OUT THE INVENTION

The present invention will be described in detail below based on an embodiment thereof.

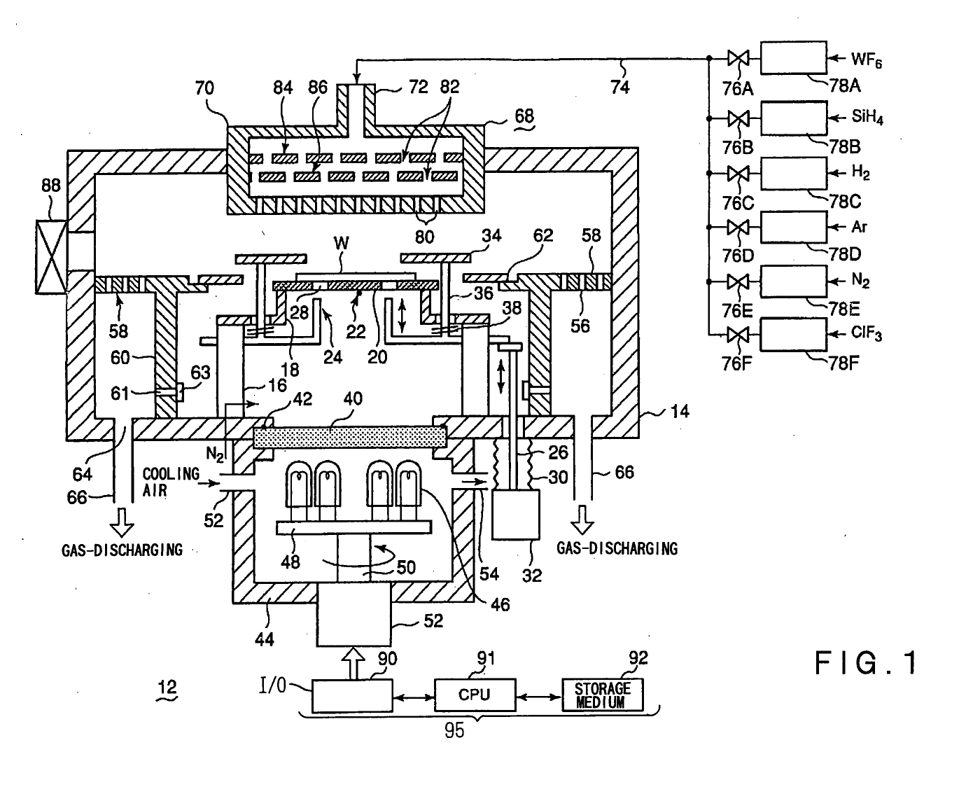

FIG. 1 is a schematic structural view showing an embodiment of a heat processing apparatus according to the present invention. The heat processing apparatus 12 in this embodiment is an apparatus that forms a tungsten film with the use of a WF₆ gas and a monosilane (SiH₄) gas.

The heat processing apparatus 12 includes a processing vessel 14 made of aluminum or the like and having a cylindrical or box-like shape. Disposed in the processing vessel 14 is a cylindrical column 16 standing up from a bottom of the vessel. On an upper end of the column 16, through a holding member 18, for example, there is located a stage 20 on which a semiconductor wafer W as an object to be processed can be placed. The holding member 18 is made of a material capable of transmitting heat rays, such as quartz. The stage 20 is formed of, e.g. a carbon material or an aluminum compound having a thickness of about 1 mm. The stage 20 is provided with a thermocouple 22 for measuring a temperature of the stage 20.

Disposed below the stage 20 are a plurality of, e.g., three L-shaped lifter pins 24 projecting upward. The lifter pins 24 are connected to a push-up rod 26, which passes through the bottom of the processing vessel 14. By moving the push-up rod 26 in the up and down direction, the lifter pins 24 are moved all together in the up and down direction. The stage 20 has lifter pin holes 28 passing therethrough, so that the lifter pins 24 can lift a wafer W through the lifter pin holes 28.

A lower end of the push-up rod 26 is connected to an actuator 32 for the up and down movement of the push-up rod 26. A lower surface of the bottom of the processing vessel 14 around a portion thereof through which the push-up rod 26 passes and the actuator 32 are connected to each other by an extensible bellows 30. Thus, irrespective of the up and down movement of the push-up rod 26, a hermetically sealed state of the inside of the processing vessel 14 can be held.

Disposed at a peripheral portion of the stage 20 is a ring-shaped clamp ring 34 made of ceramics, which can hold (clamp) a peripheral portion of a wafer W and fix the peripheral portion of the wafer W onto the stage 20. The clamp ring 34 is connected to the lifter pins 24 through support rods 36, which loosely pass through the holding member 18. Thus, the clamp ring 34 is configured to be vertically moved together with the lifter pins 24.

A coil spring 38 is interposed between the support rod 36 and the lifter pin 24. This assists lowering of the clamp ring 34 and so on, and secures clamping (fixation) of a wafer. In this embodiment, the lifter pins 24 may be formed of a heat-ray transmittable member such as quartz.

An opening is formed in the vessel bottom directly below the stage 20. A transmission window 40, which is formed of a heat-ray transmittable material such as quartz, is hermetically fitted in the opening via a seal member 42 such as an O-ring.

A box-shaped heating chamber 44 is disposed below the transmission window 40 so as to surround (cover) the transmission window 40. A plurality of heating lamps 46 as heating means are arranged in the heating chamber 44. The heating lamps 46 are secured on a rotation table 48 also serving as a reflection mirror. The rotation table 48 is configured to be driven in rotation through a rotation shaft 50 by a rotation motor 52 disposed on a bottom of the heating chamber 44. Thus, heat rays emitted from the heating lamps 46 transmit through the transmission window 40 and irradiate a lower surface of the stage 20, whereby the stage 20 can be heated.

Formed in a sidewall of the heating chamber 44 are a cooling-air inlet port 52 through which a cooing air for cooling the inside of the heating chamber 44 and the transmission window 40 is introduced, and a cooling-air discharge port 54 through which the cooling air is discharged.

A ring-shaped current plate 58 with a large number of current holes 56 is supported on an outer circumferential side of the stage 20 by a support column 60 which is annularly formed in the up and down direction (formed into a hollow columnar shape). A plurality of openings 61 are formed in the support column 60 to laterally pass therethrough, and thus a space below the stage 20 can be evacuated. Each of the openings 61 is equipped with a pressure adjusting valve 63 that adjusts a pressure condition such that a wafer W is prevented from being displaced (undesirably shifted) when the wafer W is placed on the stage 20.

An upper inner circumferential portion of the support column 60 supports a ring-shaped attachment 62 made of quartz. The quartz attachment 62 is adapted to be brought into contact with an outer circumferential portion of the clamp ring 34 when a wafer W is clamped by the clamp ring 34. Thus, when a wafer W is clamped by the clamp ring 34, it can be prevented that a gas flows down below the clamp ring 34.

An exhaust port 64 is formed in the bottom of the processing vessel 14 below the current plate 58. Connected to the exhaust port 64 is an exhaust channel 66 in which a vacuum pump and a pressure adjusting valve, which are not shown, are disposed. Thus, the processing vessel 14 can be uniformly evacuated, for example. Further, an inert gas such as an N₂ gas can be supplied into the space below the stage 20.

On the other hand, there is also formed an opening in a ceiling part of the processing vessel 14 opposed to the stage 20. Fitted in the opening is a gas introducing means, e.g., a showerhead 68, which introduces into the processing vessel 14 a required predetermined gas, such as a process gas or a cleaning gas.

To be specific, the showerhead 68 has a head body 70, which is formed of an aluminum or the like and has a cylindrical box shape. A gas inlet port 72 is formed in a ceiling part of the head body 70. A gas channel 74 is connected to the gas inlet port 72. The gas channel 74 is divided into a plurality of branch channels which are respectively provided with on-off valves 76A to 76F and flow-rate controllers 78A to 78F such as mass flow controllers. In this embodiment, WF₆, SiH₄, H₂, Ar and N₂ as a film deposition gas, and ClF₃ as a cleaning gas can be selectively supplied, while their flow rates being controlled.

The kinds of gases and the structure of the gas supply system used in this embodiment are merely taken by way of example, and do not limit the present invention. For example, as a film deposition gas, there may be used gases of an organic compound, a nitride, and an oxide, in addition to a gas of an inorganic compound that can be used when a film containing a metal is formed. Further, as a cleaning gas, NF₃, HC₁, F₂, Cl₂, and the like may be used.

On the other hand, there are uniformly formed, in a lower surface (surface opposed to the stage 20) of the head body 70, a large number of gas holes 80 for emitting a gas that has been supplied into the head body 70. Thus, the gas can be uniformly emitted over the whole wafer surface.

Moreover, two diffusion plates 84 and 86, each having a large number of gas diffusion holes 82, are arranged in parallel in a vertical two-step manner in the head body 70. Thus, it is possible to more uniformly supply the gas over the whole wafer surface.

In addition, a sidewall of the processing vessel 14 is equipped with a gate valve 88, which can be opened and closed when a wafer W is loaded into and unloaded from the processing vessel 14. Further, the heat processing apparatus 12 includes a control device 95 that controls the overall operation of the heat processing apparatus 12. The control device 95 has, for example, a central processing unit (CPU) 91, and a hardware unit 90 formed of a microcomputer (functioning as an I/O for the heat processing apparatus 12) and the like. Moreover, the control device 95 has a storage medium 92 that stores a program for controlling the overall operation of the heat processing apparatus 12. The storage medium 92 is formed of, e.g., a floppy disk, a flash memory, an MO, a DVD, or a RAM.

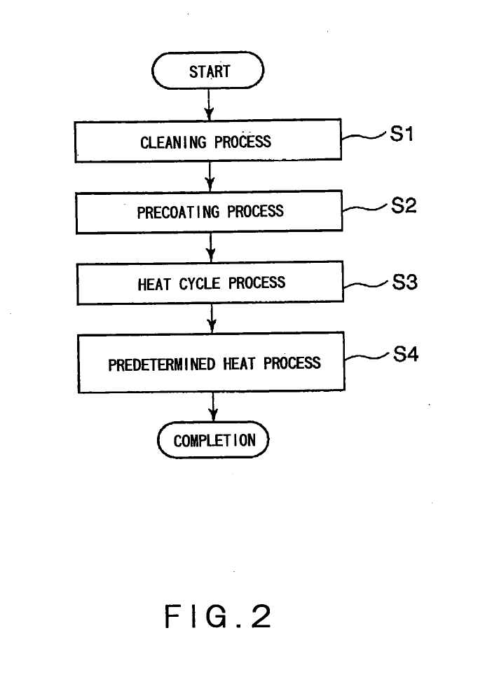

Next, an operation of the heat processing apparatus 12 in this embodiment as structured above is described with reference also to FIGS. 2 to 6.

The control of the overall heat processing apparatus 12, including below-described operations, i.e., a control of the gas introducing system, such as a control of start and stop of the supply of respective gases and a control of flow rates of the respective gases, and a control of the power system, such as a control of a supply power to the heating lamps 46 based on a detected value of the thermocouple 22, are performed by the CPU 91 based on the program stored in the storage medium 92.

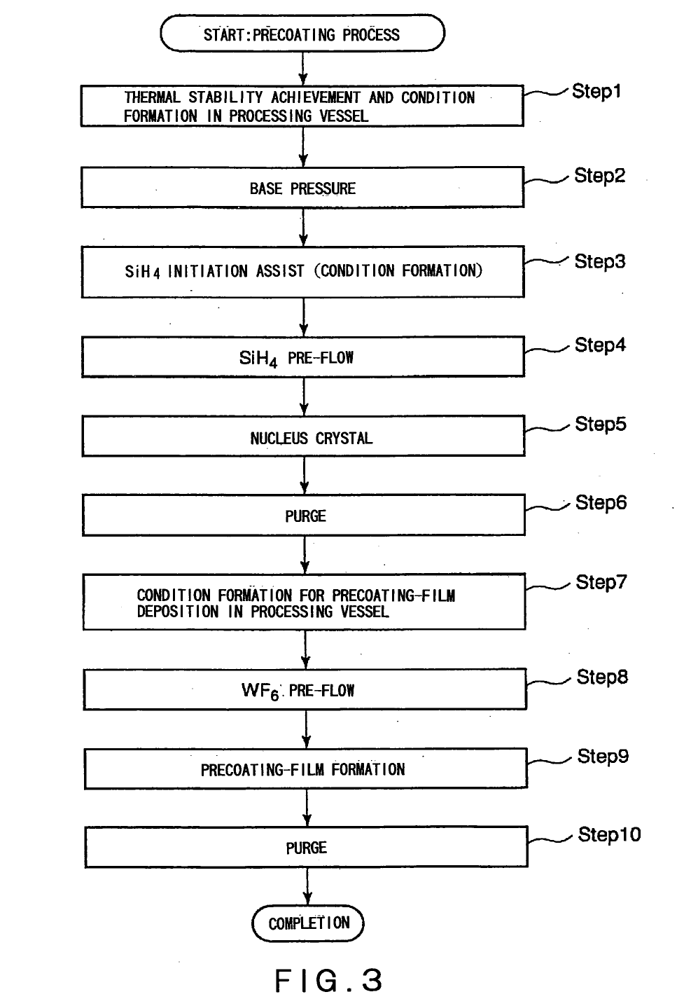

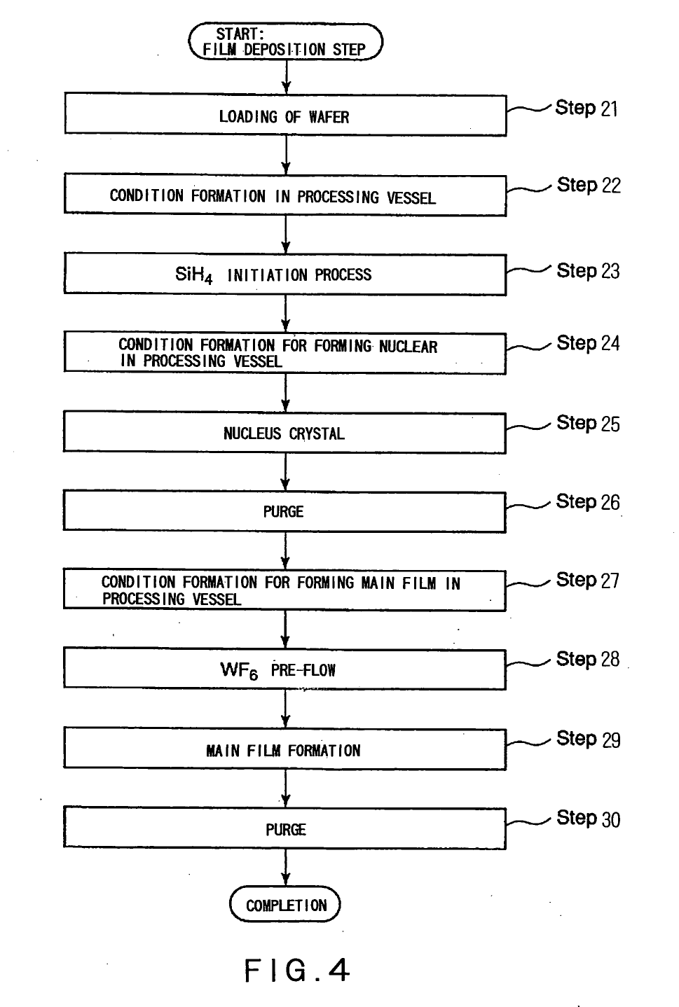

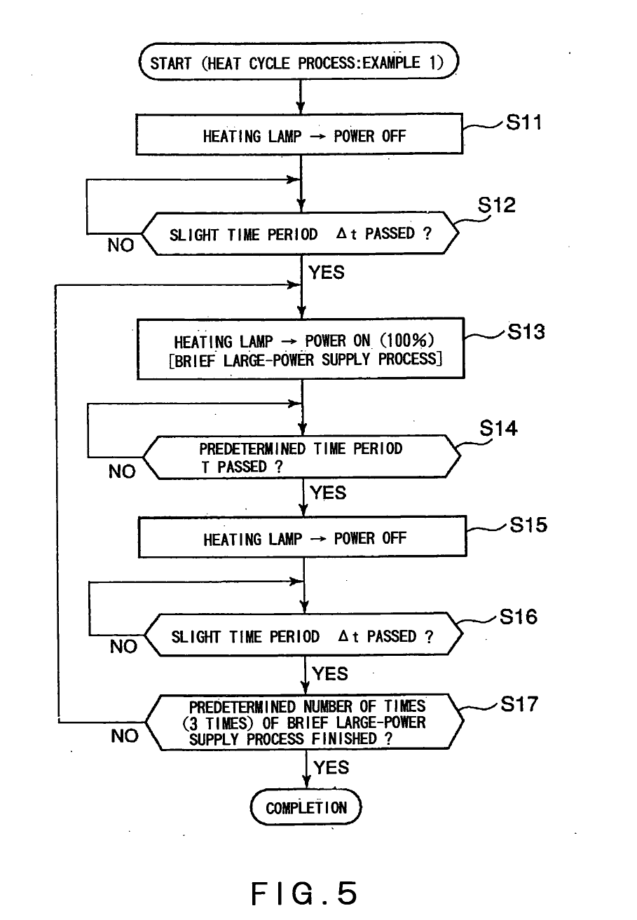

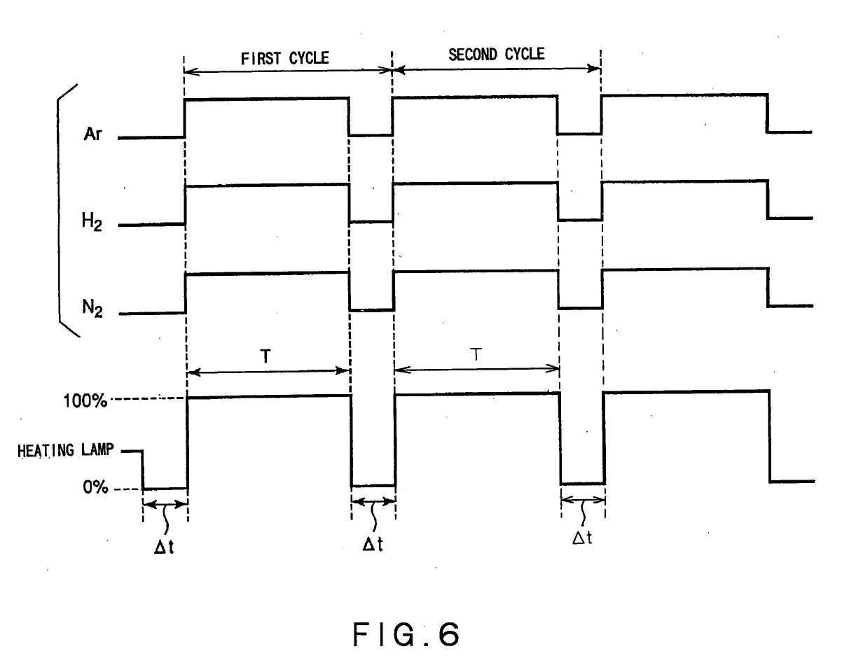

FIG. 2 is a flowchart showing an overall flow of a process performed by the heat processing apparatus shown in FIG. 1. FIG. 3 is a flowchart showing details of an example of the precoating process shown in FIG. 2. FIG. 4 is a flowchart showing details of a film deposition process of depositing a tungsten film as an example of the film deposition process shown in FIG. 2. FIG. 5 is a flowchart showing details of an example of the heat cycle process shown in FIG. 2. FIG. 6 is a timing chart showing supply conditions of respective gases and a supply power to the heating lamps, in the example of the heat cycle process shown in FIG. 5.

The overall process of the heat processing apparatus 12 is performed as shown in FIG. 2. Namely, a cleaning process is firstly performed (S1) for removing a deposition adhering to the inside of the processing vessel 14. Then, a precoating process is performed (S2) for stabilizing thermal conditions in the processing vessel 14. Subsequently, a heat cycle process, which is a feature of the present invention, is performed (S3) for stabilizing a temperature in the processing vessel 14. Thereafter, a predetermined heat process such as a film deposition process is performed (S4) to a wafer. The respective processes are described one by one below.

<Cleaning Process>

In the heat processing apparatus 12, after a film deposition process is performed to at least one or more wafers W, e.g., 25 wafers of one lot, or after a film deposition process is performed by a predetermined accumulated thickness, a large amount of unnecessary film, for example a film containing a metal such as tungsten or a film containing Si, and a large amount of reaction product, are deposited on the surfaces of the inside elements. With a view to removing these, the cleaning process is performed (S1).

When the cleaning process is performed, a ClF₃ gas as a cleaning gas (etching gas), for example, is introduced into the processing vessel 14 in which no wafer W has been received (the processing vessel 14 is vacant). Thus, the large amount of unnecessary deposition film (which will become particles) adhering to the surfaces of the inside elements are removed. At this time, the processing vessel 14 is continuously evacuated.

In such a cleaning process, since a reactivity (corrosiveness) of the cleaning gas is high, in order to protect the inside elements against the cleaning gas, a temperature of the stage 20 is set at, e.g., about 250° C. which is a temperature that is lower than a temperature for the film deposition (e.g., 460° C.) and that enables the unnecessary deposition film deposited on the inside elements to be easily removed. Preferably, the temperature is between 100° C. and 300° C.

As the cleaning process, a remote plasma cleaning process may be utilized, in which a cleaning gas containing an NF₃ gas or the like is supplied into another chamber (not shown) so as to generate therein a plasma and then the plasma is supplied into the processing vessel 14. In this case, the cleaning gas may include gases such as Ar, F₂, Cl₂, and HCl, and at least one or more gases out of F₂, Cl₂, and HCl is used.

<Precoating Process>

After the above cleaning process has been performed for a predetermined period of time, the precoating process is performed (S2).

When the precoating process is performed, various gases such as WF₆, SiH₄, H₂, and Ar similar to the below-described film deposition process are caused to flow into the processing vessel 14 in which no wafer W is received (the processing vessel 14 is vacant). A process pressure and a process temperature are set substantially similarly to those for the film deposition process. Then, the precoating process is performed, e.g., only once, for the same time period as required for one wafer W to be film-deposited, for example. Thus, a thin deposition film adheres to the surfaces of the inside elements, so that the thermal conditions of the processing vessel 14 can be stabilized. A concrete example of the precoating process is described with reference to FIG. 3.

As shown in FIG. 3, at a Step 1, an Ar gas, an H₂ gas, and an N₂ gas are caused to flow into the processing vessel 14 in which no wafer is received (the processing vessel 14 is vacant), and the temperatures of the inside elements and the in-vessel pressure are stabilized. Namely, simultaneously with the achievement of the thermal stability in the processing vessel, a condition suitable for stably forming a precoating film is formed.

Process conditions at this step are as follows.

The flow rates of the respective gases are as follows. The flow rate of the Ar gas is preferably within a range between 500 sccm and 5000 sccm, and is set at e.g., 2700 sccm. The flow rate of the H₂ gas is preferably within a range between 500 sccm and 3000 sccm, and is set at, e.g., 1800 sccm. The flow rate of the N₂ gas is preferably within a range between 200 sccm and 2000 sccm, and is set at, e.g., 900 sccm.

The process period is preferably within a range between 60 seconds and 600 seconds, and is set at, e.g., 300 seconds. The process pressure is preferably within a range between 400 Pa and 103333 Pa, and is set at, e.g., 10666 Pa.

The process temperature is preferably within a range between 300° C. to 600° C., and is set at, e.g., 460° C., which remains unchanged throughout the following steps.

Then, at a Step 2, the supply of the respective gases is stopped and the processing vessel 14 is totally evacuated (to create a vacuum therein) to make a base pressure (remaining gases are discharged). At this step, an inert gas is preferably supplied, but the supply thereof is dispensable.

Then, at a Step 3, Ar, SiH₄, H₂, and N₂ are supplied, and the in-vessel pressure is stabilized. Thus, a condition suitable for a nucleus-crystal film deposition is formed.

Process conditions at this step are as follows.

The flow rates of the respective gases are as follows. The flow rate of the Ar gas is preferably within a range between 50 sccm and 2000 sccm, and is set at e.g., 250 sccm. The flow rate of the SiH₄ gas is preferably within a range between 1 sccm and 100 sccm, and is set at e.g., 10 sccm. The flow rate of the H₂ gas is preferably within a range between 100 sccm and 3000 sccm, and is set at, e.g., 400 sccm. The flow rate of the N₂ gas is preferably within a range between 10 sccm and 2000 sccm, and is set at, e.g., 350 sccm.

The process period is set at, e.g., 37 seconds. The process pressure is preferably within a range between 400 Pa and 103333 Pa, and is set at, e.g., 500 Pa.

Then, at a Step 4, WF₆ is caused to pre-flow to the outside of the processing vessel, while SiH₄ is caused to pre-flow into the processing vessel 14.

Then, at a Step 5, a valve (not shown) is switched from the state in the Step 4, so that the WF₆ gas is caused to flow into the processing vessel. Thus, a nucleus crystal of tungsten grows.

Process conditions at this step are as follows.

The flow rates of the respective gases are as follows. The flow rate of the WF₆ gas is preferably within a range between 5 sccm and 100 sccm, and is set at e.g., 22 sccm. The other conditions are the same as those in the Step 3.

Then, at a Step 6, the supply of the WF₆ gas and the SiH₄ gas is stopped (the other gases are continuously caused to flow), and these gases (remaining gases) are discharged to create a vacuum (purged).

Then, at a Step 7, the flow rate of the Ar gas is increased so as to elevate the pressure, and the pressure in the processing vessel 14 is stabilized at a predetermined pressure (precoating-film formation pressure). Namely, a condition suitable for forming a precoating film can be formed in the processing vessel.

Process conditions at this step are as follows.

The flow rates of the respective gases are as follows. The flow rates of the Ar gas, the H₂ gas, and the N₂ gas are the same as or higher than those (Ar: 900 sccm, H₂: 750 sccm, N₂: 100 sccm) for the following W-film deposition condition (condition in Step 8). For example, the flow rate of the Ar gas may be 2700 sccm, the flow rate of the H₂ gas may be 1880 sccm, and the flow rate of the N₂ gas may be 900 sccm.

The process period is set at, e.g., 25 seconds, and the process pressure is set at, e.g. 10666 Pa.

Thus, a condition suitable for forming a tungsten film is formed.

Then, at a Step S8, from the condition of the Step 7, the WF₆ gas is briefly caused to pre-flow to the outside of the processing vessel 14 at a flow rate of 80 sccm. At the same time, process conditions are set as follows.

The flow rate of the WF₆ gas is preferably within a range between 10 sccm and 300 sccm, and is set at, e.g., 80 sccm. The flow rate of the Ar gas is preferably within a range between 100 sccm and 3000 sccm, and is set at, e.g., 900 sccm. The flow rate of the H₂ gas is preferably within a range between 100 sccm and 3000 sccm, and is set at, e.g., 750 sccm. The flow rate of the N₂ gas is preferably within a range between 10 sccm and 1000 sccm, and is set at, e.g., 100 sccm.

The process period is set at, e.g., 100 seconds. The process pressure is preferably within a range between 400 Pa and 103333 Pa, and is set at, e.g., 10666 Pa.

Then, at a Step 9, a valve (not shown) is switched from the state in the Step 8, so that the WF₆ gas is caused to flow into the processing vessel. Thus, the film deposition process of depositing a tungsten film is performed, whereby a precoating film is deposited on the surfaces of the in-vessel elements such as the stage.

Then, at a Step 10, the supply of the WF₆ gas and the SiH₄ gas is stopped (the other gases are continuously caused to flow), and the remaining gases in the processing vessel 14 are removed (purged).

When the precoating process is completed as described above, the next film deposition process for depositing a film on a substrate immediately follows thereto in general. However, in this embodiment, before the performance of the next film deposition process, the heat cycle process is performed, which is a feature of the present invention (see, FIG. 2).

For example, when next (following) the film deposition process is consecutively performed as in the general (conventional) manner, the peripheral portion of the wafer W is pressed by the clamp ring 34. Namely, the clamp ring 34 is brought into direct contact with the wafer W. In addition, the stage 20 and the lower surface of the clamp ring 34 are irradiated and heated by heat rays from the lamps 46, whereby the wafer W is heated.

However, in this case, because of the insufficient irradiation of the heat rays from the lamps 46 to the clamp ring 34, and also because of the heat radiation of the clamp ring 34, the temperature of the clamp ring 34 cannot be stably held at the temperature of the stage 20. Namely, the temperature of the clamp ring 34 is maintained at, e.g., 380° C. to 420° C., which is considerably, i.e., by 30° C. to 70° C., lower than the film deposition temperature. Thus, in particular, in some wafers which are processed immediately after the start of the next film deposition process, uniformity of a film thickness and uniformity of a sheet resistance between surfaces of the wafers are deteriorated.

This point is described in more detail below. In the precoating process, the temperature of the stage 20, which directly receives the heat rays from the heating lamps 46, can easily reach the temperature for the film deposition, i.e., about 460° C., for example. On the other hand, the inside elements except the stage 20 cannot directly receive the heat rays from the heating lamps 46. Thus, these inside elements are not thermally directly controlled (these inside elements are heated only by radiant heat and heat transmission). Namely, the clamp ring 34 and the like, which are the inside elements except the stage 20, do not directly receive the heat rays from the heating lamps 46. Thus, in a case where the number of times of the precoating process is small and thus the clamp ring 34 and the like are exposed to a high temperature only for a short time period, the temperatures of the clamp ring 34 and the like remain considerably lower than the temperature for the film deposition.

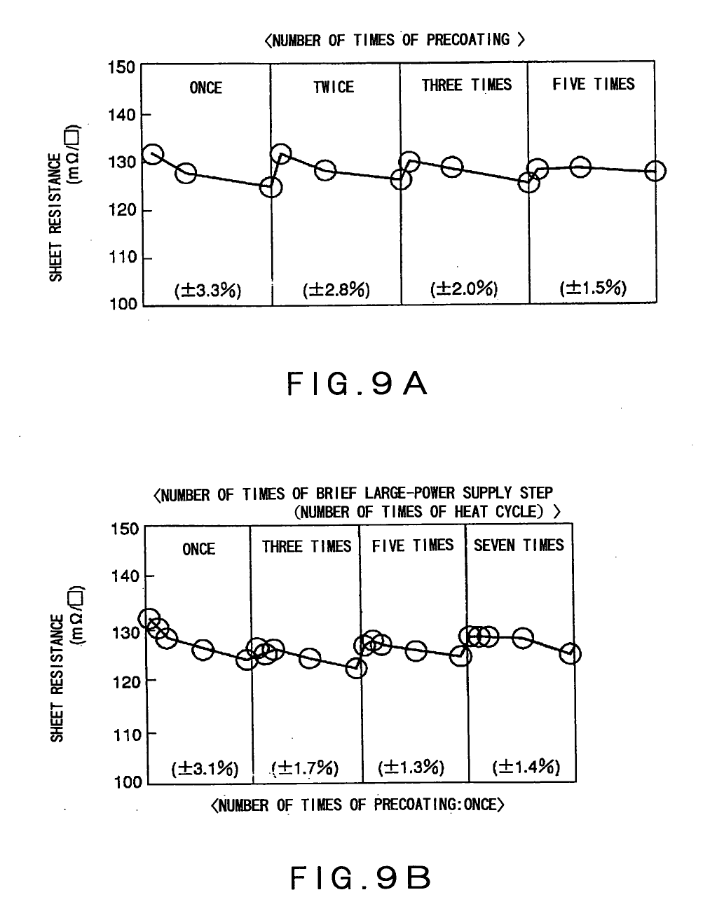

In this case, as shown FIG. 9A, which will be described below, if the precoating process is performed many times, the temperatures of the clamp ring 34 and the like can be increased little by little during the repeated precoating processes, and can reach the temperature for the film deposition at last. However, when the precoating process has to be performed five times or more, a long time period is required as a whole, because each precoating process needs about 9 minutes. This invites deterioration in throughput.

Accordingly, in this embodiment, the precoating process is performed only once, and thereafter the heat cycle process, which is a feature of the present invention, is preformed (see FIG. 2).

<Heat Cycle Process>

Next, the heat cycle process, which is a feature of the present invention, is described. The heat cycle process is performed immediately before the film deposition process as a predetermined heat process to a wafer W.

In the heat cycle process, under a state in which a wafer W is maintained at a temperature that is lower than the film deposition temperature (specifically, under a state after the cleaning process or under a waiting (idling) state), a power, which is larger than another power that has been applied to the heating lamps 46 when the wafer W has been maintained at the film deposition temperature during the film deposition process, is briefly applied to the heating lamps 46 (brief large-power supply step). In the heat cycle process, the brief large-power supply step is performed at least once.

As described below, the brief large-power supply step is preferably repeated. For example, it is desirable that an OFF state of the heating lamps 46 and an ON state thereof, in which a power corresponding to 100% of a rated power of the heating lamps 46 is supplied, are briefly alternately performed in a repeated manner. Herein, when the power corresponding to 100% of the rated power is supplied to the heating lamps 46, it is preferable to cause gases such as Ar, H₂, and N₂ to flow into the processing vessel 14, so as to enhance heat transfer performance by a convection inside the processing vessel 14. That is to say, while supplying a process gas, it is preferable that the power supply to the heating source and the stop thereof are alternately performed at least more than once. Thus, the temperatures of the inside elements such as the clamp ring and the wall surface of the processing vessel can be elevated, to thereby improve the thermal stability of these elements.

More detailed description of the heat cycle process is made hereinafter.

<Film Deposition Process>

After the aforementioned heat cycle process is completed, a heat process such as the film deposition process is then performed (S4).

When the film deposition process as a heat process is performed to a wafer W, the gate valve 88 formed in the partition wall of the processing vessel 14 is opened, and the wafer W is loaded into the processing vessel 14 by the transfer arm (not shown). Meanwhile, the lifter pins 24 are pushed upward, and the wafer W is delivered onto the raised lifter pins 24. The lifter pins 24 are lowered by moving the push-up rod 26 downward. Thus, the wafer W can be placed on the stage 20. By further moving the push-up rod 26 downward, a peripheral portion of the wafer W is pressed by the clamp ring 34 so as to be fixed.

Then, for example, WF₆, H₂, and so on are supplied as a process gas into the showerhead 68 and are mixed therein. The mixed gas is uniformly supplied into the processing vessel 14 through the gas holes 80 formed in the lower surface of the head body 70. At the same time, the inside atmosphere is sucked and discharged through the exhaust port 64, so that the inside of the processing vessel 14 is maintained at a predetermined vacuum degree.

In addition, the heating lamps 46 in the heating chamber 44 are driven in rotation while radiating heat energy. The heat rays radiated from the heating lamps 46 transmit through the transmission window 40, and then irradiate the rear surface of the stage 20 to heat the same. As described above, since the stage 20 is as thin as about 1 mm, the stage 20 can be quickly heated. Thus, the wafer W placed thereon can also be quickly heated to a predetermined temperature, e.g., about 460° C.

Thereafter, the mixed gas that has been supplied into the processing vessel 14 induces a predetermined chemical reaction, whereby a tungsten film, for example, is deposited and formed on the surface of the wafer W.

A concrete example of the film deposition process for a tungsten film is described with reference to FIG. 4.

As shown in FIG. 4, at a Step 21, a wafer W is firstly loaded into the processing vessel 14, and the clamp ring 34 is lowered.

Then, at a Step 22, Ar, SiH₂ (dispensable at the Step 22), and H₂ are supplied, and the temperature of the wafer W and the in-vessel pressure are increased and stabilized by respective control units (SiH₄ fulfills a role of an initiation assist). Thus, the inside of the processing vessel can be made thermally stable, and a condition suitable for a stable film deposition can be formed in the processing vessel.

Process conditions at this step are as follows.

The flow rates of the respective gases are as follows. The flow rate of the Ar gas is preferably within a range between 100 sccm and 5000 sccm, and is set at, e.g., 2700 sccm. The flow rate of the SiH₄ gas is preferably within a range between 1 sccm and 100 sccm (the same flow rate as that of the following Step 23 is particularly preferred), and is set at, e.g. 18 sccm. The flow rate of the H₂ gas is preferably within a range between 100 sccm and 3000 sccm, and is preferably set at, e.g., 1000 sccm.

The process period is set at, e.g., 25 seconds. The process pressure is preferably within a range between 400 Pa and 103333 Pa, and is set at, e.g., 10666 Pa.

The process temperature is preferably within a range between 300° C. to 600° C., and is set at, e.g., 440° C., which remains unchanged throughout the following step.

Then, at a Step 23, the supply of the Ar gas is stopped while the supply of the SiH₄ gas and the H₂ gas are continued, and an SiH₄ initiation process is performed.

Process conditions at this step are as follows.

The flow rates of the respective gases are as follows. The flow rate of the SiH₄ gas is preferably within a range between 1 sccm and 100 sccm, and is set at, e.g., 18 sccm. The flow rate of the H₂ gas is preferably within a range between 100 sccm and 3000 sccm, and is set at, e.g., 100 sccm.

The process period is preferably within a range between 10 seconds and 360 seconds, and is set at, e.g., 40 second. The process pressure is preferably within a range between 400 Pa and 103333 Pa, and is set at, e.g., 10666 Pa.

Then, at a Step 24, simultaneously with the stop of the supply of the SiH₄ gas, the N₂ gas is supplied. In addition, the in-vessel pressure is decreased (e.g., to 500 Pa).

Further, the WF₆ gas and the SiH₄ gas are caused to flow through an EVAC line (caused to directly flow into the exhaust system via a line bypassing the processing vessel 14 (pre-flow)), and the flow rates thereof are stabilized. Thus, a condition suitable for a nucleus crystal growth can be formed in the processing vessel.

Then, at a Step 25, a valve (not shown) is switched from the state in the Step 24, so that the WF₆ gas and the SiH₄ gas are caused to flow into the processing vessel. Thus, a tungsten nucleus crystal can grow.

Process conditions at this step are as follows.

The flow rates of the respective gases are as follows. The flow rate of the WF₆ gas is preferably within a range between 1 sccm and 100 sccm, and is set at, e.g., 22 sccm. The flow rate of the Ar gas is preferably within a range between 100 sccm and 5000 sccm, and is set at, e.g., 2000 sccm. The flow rate of the SiH₄ gas is preferably within a range between 1 sccm and 100 sccm, and is set at 18 sccm. The flow rate of the H₂ gas is preferably within a range between 100 sccm and 3000 sccm, and is set at, e.g., 400 sccm. The flow rate of the N₂ gas is preferably within a range between 5 sccm and 2000 sccm, and is set at, e.g., 600 sccm.

The process period is preferably within a range between 1 second and 120 seconds, and is set at, e.g., 13 seconds. The process pressure is preferably within a range between 400 Pa and 103333 Pa, and is set at, e.g., 2667 Pa.

Then, at a Step S26, the supply of the WF₆ gas and the SiH₄ gas is stopped (the other gases are continuously caused to flow), and the remaining gases of the film deposition gas are removed (purged).

Then, at a Step 27, in order to facilitate activation of the gases that have been supplied at the Step 26, the pressure is increased (e.g., to 10666 Pa). Then, the thermal stability can be improved, and the pressure in the processing vessel 14 can be stabilized. Thus, a condition suitable for forming a main film can be formed in the processing vessel.

The flow rates of the respective gases are as follows. The flow rates of the Ar gas, the H₂ gas, and the N₂ gas are the same as or higher than those (Ar: 900 sccm, H₂: 750 sccm, N₂: 100 sccm) for the following W-film deposition condition (condition in Step 29). For example, the flow rate of the Ar gas may be 2700 sccm, the flow rate of the H₂ gas may be 1880 sccm, and the flow rate of the N₂ gas may be 900 sccm.

The process period is set at, e.g., 25 seconds, and the process pressure is set at, e.g., 10666 Pa.

Then, at a Step 28, the gas flow rates are decreased from the state in the Step 27, according to need, so as to set a film deposition condition (Step 29). Further, the WF₆ gas is caused to pre-flow to the outside of the processing vessel 14.

The process period is set at, e.g., 3 seconds, and the process pressure is set at, e.g., 10666 Pa.

Then, at a Step 29, a valve (not shown) is switched from the state in the Step 28, whereby the WF₆ gas is caused to flow into the processing vessel. Thus, the main-film deposition process for a tungsten film is performed.

Process conditions at this step are as follows.

The flow rates of the respective gases are as follows. The flow rate of the WF₆ gas is preferably within a range between 1 sccm and 100 sccm, and is set at, e.g., 80 sccm. The flow rate of the Ar gas is preferably within a range between 100 sccm and 5000 sccm, and is set at, e.g., 900 sccm. The flow rate of the H₂ gas is preferably within a range between 100 sccm and 3000 sccm, and is set at, e.g., 750 sccm. The flow rate of the N₂ gas is preferably within a range between 5 sccm and 2000 sccm, and is set at, e.g., 100 sccm.

The process period is set at, e.g., 23 seconds, and the process pressure is set at, e.g., 10666 Pa.

Then, at a Step 30, the supply of the WF₆ gas is stopped (the other gases are continuously caused to flow), and the remaining gases of the film deposition gas remaining in the processing vessel 14 after the main-film deposition process are removed (purged).

By the above Steps 21 to 30, the film deposition process of a tungsten film is completed. That is, a series of steps are completed in the manner as described above.

<Details of Heat Cycle Process>

Next, the aforementioned heat cycle process is described in more detail.

As has been described above, in the heat cycle process, immediately before the film deposition process as a predetermined heat process to a wafer W, under a state in which the wafer W is maintained at a temperature that is lower than the film deposition temperature (specifically, under a state after the cleaning process or under a waiting (idling) state), there is performed at least once the brief large-power supply step, in which a power, which is larger than another power that has been applied to the heating lamps 46 when the wafer W has been maintained at the film deposition temperature during the film deposition process, is briefly applied to the heating lamps 46.

The brief large-power supply step is preferably repeated. For example, it is desirable that an OFF state of the heating lamps 46 and an ON state thereof, in which a power corresponding to 100% of a rated power of the heating lamps 46 is supplied, are briefly alternately performed in a repeated manner. Herein, when the power corresponding to 100% of the rated power is supplied to the heating lamps 46, it is preferable to cause gases such as SiH₄, H₂, and N₂, and/or an inert gas such as Ar to flow into the processing vessel 14, so as to enhance heat transfer performance by a convection inside the processing vessel 14.

A concrete example 1 of the heat cycle process is described with reference to FIGS. 5 and 6. In the example 1, the brief large-power supply step is performed three times, i.e., the heat cycle is performed three times. In addition, in the example 1, at the respective brief large-power supply steps, the apparatus is controlled such that a power corresponding to 100% of the allowable value is outputted from the heating lamps 46.

As shown in FIG. 5, after the precedent precoating process is completed, a supply power to the heating lamps 46 is turned off (S11). The OFF state (output: 0%) of the heating lamps 46 is continued for a slight (very short) time period Δt (NO at S12). The slight time period Δt is, e.g., about 10 seconds, preferably 1 second to 30 seconds.

After the OFF state of the supply power has been continued for the slight time period Δt (YES at 512), the supply power to the heating lamps 46 is turned on. At this step, as a power which is larger than another power that has been applied to the heating lamps 46 when the wafer W has been maintained at the process temperature for the film deposition, a maximum allowable power (output: 100%) of the heating lamps 46 is supplied to the heating lamps 46 (S13). This power supply state is continued for a predetermined brief time period T (see, NO at S14 and FIG. 6). During the predetermined time period T, as shown in FIG. 6, gases such as Ar, H₂, and N₂ are introduced into the processing vessel 14, and the pressure in the processing vessel 14 is increased. By introducing these gases into the processing vessel 14 so as to increase the pressure therein, the heat transfer performance inside the vessel by the convention can be improved, whereby heating of the inside elements except the stage 20 (for example, members located near the wafer such as the attachment and the clamp ring) can be promoted.

The predetermined time period T is in a range between 1 second and 120 seconds, preferably between 1 second and 60 seconds, and is set at e.g., about 60 seconds. When the time period T is shorter than 1 second, the effect by performing the heat cycle process may be drastically lost. On the other hand, when the time period T is longer than 120 seconds, the temperatures of the inside elements may be excessively increased and decrease in throughput may be caused.

The flow rates of the gases are as follows. The flow rate of the Ar gas is in a range between 30 sccm and 6000 sccm, and is set at, e.g., 3700 sccm. The flow rate of the H₂ gas is in a range between 20 sccm and 2000 sccm, and is set at, e.g., 1800 sccm. The flow rate of the N₂ gas is in a rage between 10 sccm and 2000 sccm, and is set at, e.g. 900 sccm. At least one or more kinds of gases are used. The process pressure is set at, e.g., 10666 Pa.

The first brief large-power supply step is finished as described above (YES at S14), the supply power to the heating lamps 46 is again turned off, and the supply of the respective gases is stopped (S15). This OFF state (output: 0%) is continued for a slight time period Δt, e.g., for 10 seconds (NO at S16), which is similar to the step S12.

Herein, the duration of time “Δt+T” defines one cycle. The duration of the slight time period Δt is in a range between 1 second and 60 seconds, preferably between 5 seconds and 20 seconds. When the slight time period Δt is shorter than 1 second, there is a possibility that the temperatures of the inside elements located near the wafer are excessively increased. On the other hand, when the slight time period Δt is longer than 60 seconds, there is a possibility that the temperatures of the inside elements such as the clamp ring 34 are excessively decreased, whereby the effect by performing the heat cycle process may be significantly lost and a decrease in throughput man be invited.

After the OFF state of the supply power is continued for the slight time period Δt (YES at S16), it is judged whether the brief large-power supply step is performed predetermined times, e.g., 3 times, or not. When the number is less than three (NO at S17), the program returns to the step S13 and the above-described steps S13 to S17 are repeated.

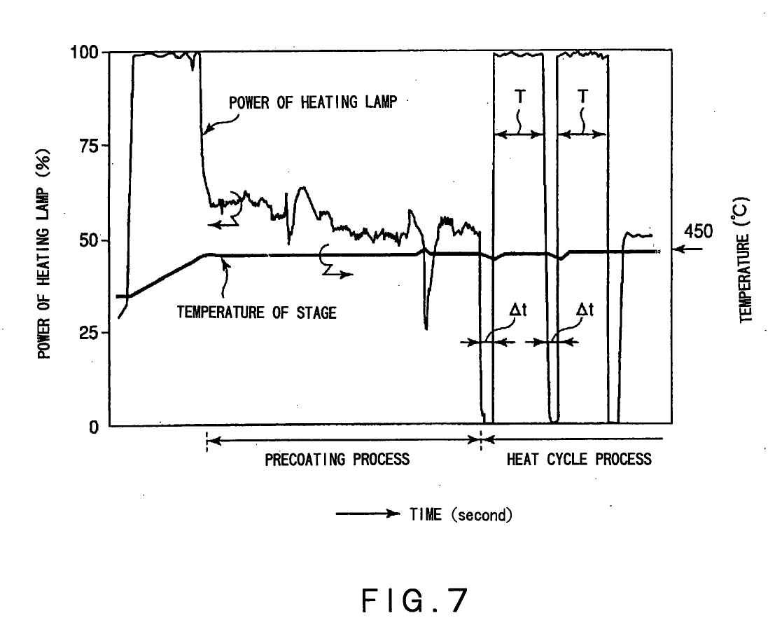

FIG. 7 is a graph showing a relationship between a power supplied to the heating lamps and a temperature of the stage, during the precoating process and the succeeding heat cycle process. FIG. 7 shows a case in which the brief large-power supply step was performed twice, namely the heat cycle process of two cycle was performed.

As shown in FIG. 7, after the supply power was turned off for the slight time period Δt, the supply power to the heating lamps 46 reached 100% and was held thereat for the predetermined time period (brief time period) T. In this case, throughout the overall step-flow from the precoating process to the heat cycle process, the temperature of the stage 20 was substantially stable, although it was very slightly varied during the heat cycle process.

Returning to FIG. 5, when the brief large-power supply process is performed three times (YES at S17), the heat cycle process is completed. Then, the program proceeds to the next process step. Namely, a predetermined heat process, e.g., an actual film deposition process with the use of a product wafer is performed.

As described above, after the completion of the precoating process, by supplying a large power to the heating lamps 46 for the brief time period T, e.g., one or more times, preferably 3 times or more, the inside elements of the processing vessel 14 can be thermally stabilized. Thus, an excellent reproducibility of a film thickness in the film deposition process can be maintained, without practically lowering throughput.

Regarding the number of times of the heat cycle, when the heat cycle is performed, e.g., about 10 times, the thermal stability is substantially saturated. Thus, the further heat cycle process only impairs throughput greatly, which is undesirable.

A method according to the present invention and a conventional method not including any heat cycle process were performed and evaluated. The evaluation results are described. Herein, a case in which three wafers were processed is described by way of example. A temperature of the wafer during the film deposition step was set at 450° C.

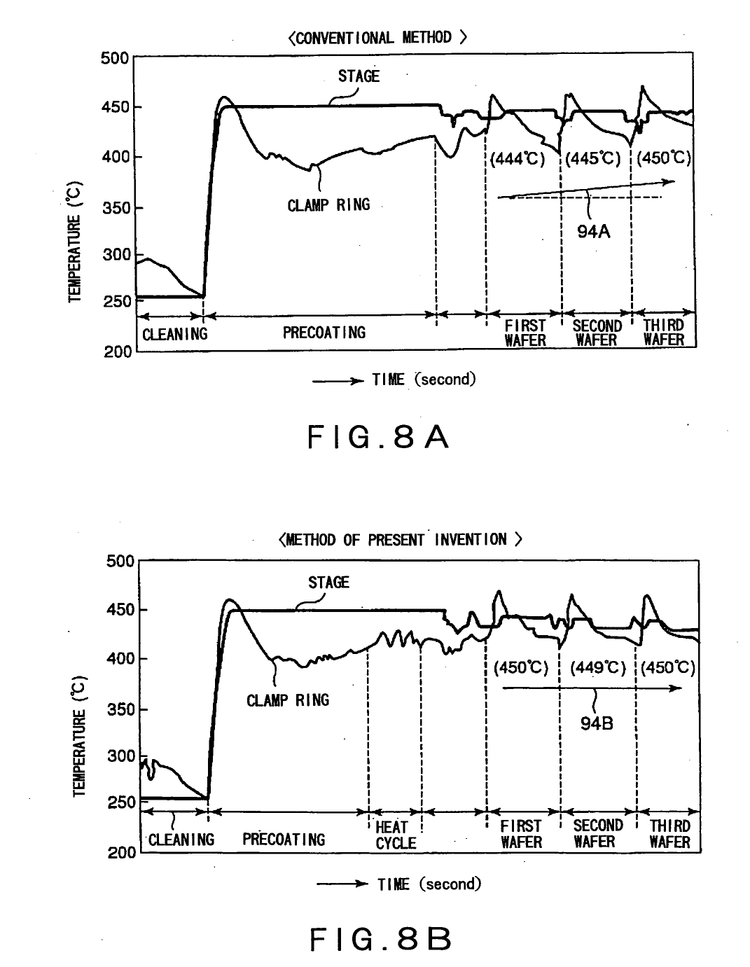

FIG. 8A is a graph showing temperature changes of a stage and a clamp ring when the conventional method was performed. FIG. 8B is a graph showing temperature changes of a stage and a clamp ring when the method according to the present invention was performed.

As shown in FIG. 8A, in the conventional method, immediately after the precoating process, three wafers W were consecutively subjected to the film deposition process. In this case, although the temperature of the stage 20 was maintained at about 450° C., the temperature of the clamp ring 34, which was one of the inside elements except the stage, was lower than that of the stage at first and was increased little by little, i.e., from 444° C. to 445° C., and from 445° C. to 450° C., for each time the wafer W was processed. That is, the temperature of the clamp ring 34 was not thermally stable. Thus, a reproducibility of the film deposition process as a heat process between the surfaces of the wafers was insufficient. To be specific, it was difficult to make uniform the film thicknesses in the initial stage of the film deposition process.

On the other hand, as shown in FIG. 8B, in the method of the present invention, the heat cycle process succeeded the precoating process. Thus, the temperatures of the inside elements in the processing vessel (environmental temperature) could be rapidly elevated. As a result, the temperature of the clamp ring 34 could also be rapidly elevated. Therefore, the temperature of the clamp ring 34 during the film deposition process was not so varied but was substantially stable, i.e., at temperatures of 450° C., 449° C., and 450° C. Preferably, the variation of the temperature is within ±3%. As described above, according to the method of the present invention, the temperatures of the inside elements as typified by the clamp ring 34 can be promptly made stable, so that a reproducibility of the film deposition process between the surfaces of the wafers can be enhanced. To be specific, the film thicknesses can be made uniform.

In FIGS. 8A and 8B, the arrows 94A and 94B respectively represent a tendency of the change of the temperature of the clamp ring 34.

Next, a reproducibility of a film thickness with respect to the number of times of a precoating process in a conventional method, and a reproducibility (variation ratio) of a film thickness with respect to the number of times of a brief large-power supply step (the number of times of the heat cycle) in a method according to the present invention, were compared and studied. The comparison results are described.

FIG. 9A is a graph showing a reproducibility (variation ratio (uniformity between surfaces)) of a film thickness with respect to the number of times of the precoating process in the conventional method. FIG. 9B is a graph showing a reproducibility (variation ratio (uniformity between surfaces)) of a film thickness with respect to the number of times of the brief large-power supply step (the number of times of the heat cycle) in the method of the present invention. The axis of ordinate shows a sheet resistance which is in proportion to a film thickness. The variation ratio (reproducibility) of a film thickness is shown in each graph. The smaller (lesser) the variation ratio of a film thickness is, the more satisfactory the reproducibility is.

As shown in FIG. 9A, in the conventional method (without the heat cycle process), when the number of times of the precoating process was changed between once, twice, three times, and five times, corresponding variation ratios of a film thickness were ±3.3%, ±2.8%, ±2.0%, and ±1.5% (in the graph, out of 25 wafers per lot, the extracted results of 3 wafers are plotted). It can be understood that the larger the number of times of the precoating process is, the smaller the variation ratio of a film thickness becomes, i.e., the more improved the reproducibility is.

Based on the above result, it is found that, in order to sufficiently reduce the variation ratio of a film thickness (in order to sufficiently enhance the uniformity between the surfaces), the precoating process has to be performed 5 times or more. When the precoating process requiring about 9 minutes is performed 5 times, for example, it takes about 45 minutes. This will invite decrease in throughput.

However, in the method according to the present invention, after the precoating process was performed once, the heat cycle process was performed. When the number of times of the heat cycle was changed between once, 3 times, 5 times, and 7 times, corresponding variation ratios of a film thickness were ±3.1%, ±1.7%, ±1.3%, and ±1.4% (in the graph, out of 25 wafers per lot, the extracted results of 5 wafers are plotted).

When the number of times of the heat cycle was one, the variation ratio of a film thickness was ±3.1%. Namely, the effect of improving the film-thickness reproducibility was small. However, when the number of times of the heat cycle was three or more, the variation ratio of a film thickness was not more than ±1.7%. Namely, the effect of improving the film-thickness reproducibility could be sufficiently brought about. In other words, the three or more times of the heat cycle can produce the effect corresponding to the effect obtained by performing the precoating process 5 times. Since each heat cycle (one cycle) requires only about 1 minute, even when the heat cycle is performed three times, it takes only 3 minutes. Accordingly, as compared with the case in which the precoating process is performed 5 times, throughput can be remarkably improved. As a result, after the precoating process is performed once, it is preferable to perform the heat cycle at least once or more, preferably twice or more, more preferably three times or more.

Next, with respect to a conventional method and a method of the present invention, reproducibilities (variation ratios) of a film thickness, when actual wafers had been subjected to the film deposition process, were compared and studied. The comparison results are described.

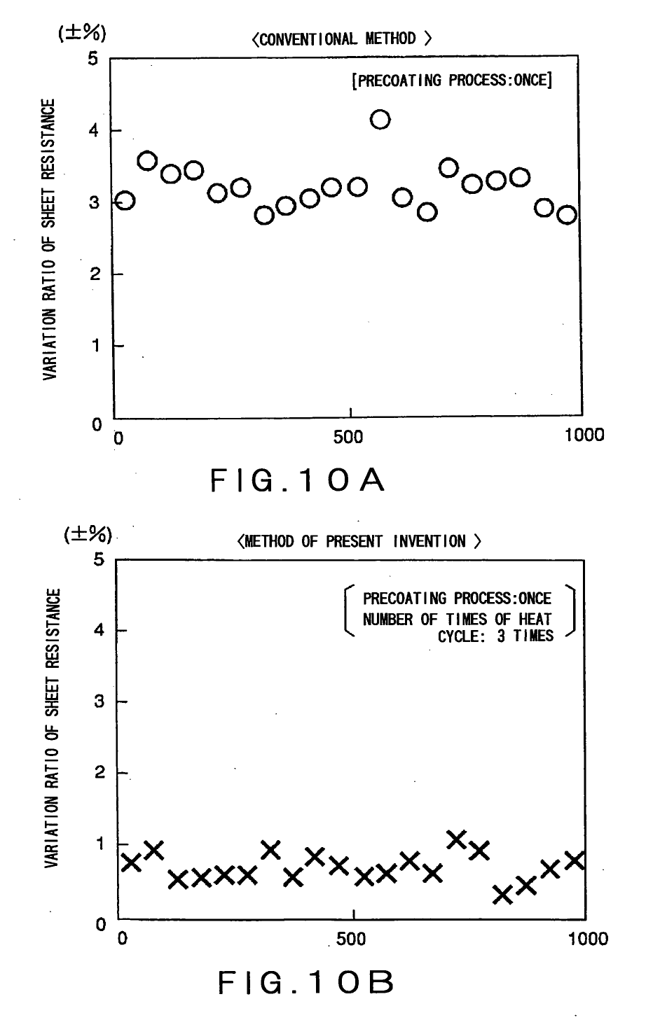

FIG. 10A is a graph showing a reproducibility (variation ratio) of a film thickness when wafers were actually subjected to a conventional film deposition process. FIG. 10B is a graph showing a reproducibility (variation ratio) of a film thickness when wafers were actually subjected to a film deposition process of the present invention. The axis of ordinate shows the variation ratio of a sheet resistance. In each graph, the precoating process was performed only once. In addition, in the graph of FIG. 10B (the method of the present invention), the number of times of the heat cycle was three.

The smaller the variation ratio of a sheet resistance is, the more satisfactory the reproducibility of a film thickness is. In each graph, the results of the variation ratios of a sheet resistance are plotted, which were calculated for each lot including 25 wafers out of 1000 processed wafers.

As apparent from FIG. 10A, in the conventional method, all the variation ratios of a sheet resistance were around 3%. Namely, it can be confirmed that the reproducibility of a film thickness was not so excellent.

On the other hand, as apparent from FIG. 10B, in the method of the present invention, the variation ratios of a sheet resistance were around ±1%. This means that the variation ratio in terms of a film-thickness variation amount could be reduced to about 30% to 40%. Namely, according to the method of the present invention, it can be confirmed that the reproducibility of a film thickness could be remarkably improved.

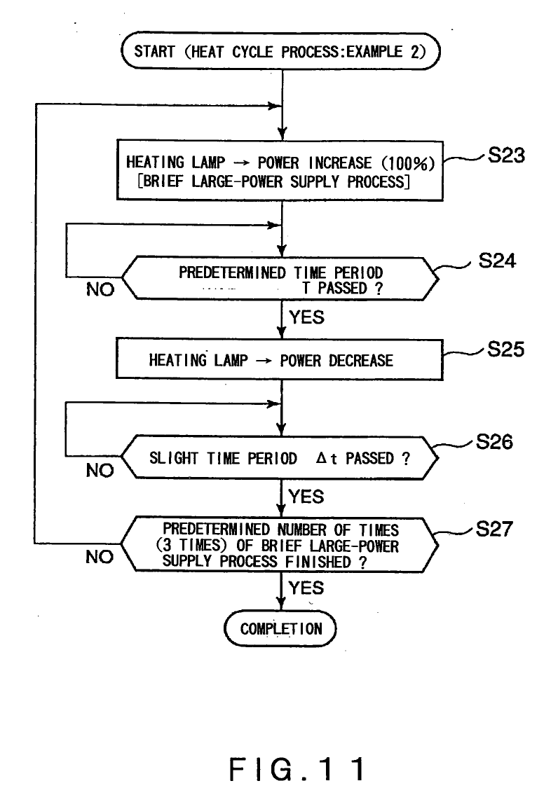

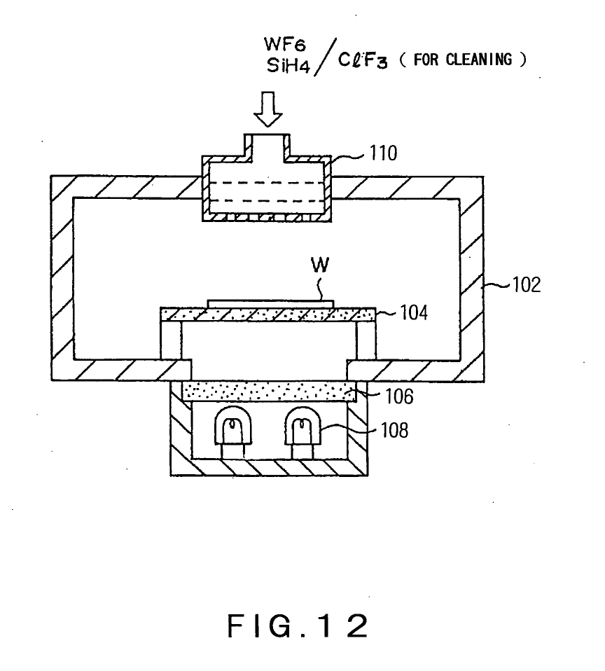

In the example 1 of the heat cycle process shown in FIGS. 5 to 7, immediately before the large power is supplied to the heating lamps 46, the supply power is temporarily turned off. However, the present invention is not limited thereto. For example, it is possible to employ an example in which the supply power is merely decreased. FIG. 11 is a flowchart showing details of such an example 2 of the heat cycle process.

Steps S23 to 27 shown in FIG. 11 respectively correspond to the steps S13 to S17 shown in FIG. 5. Description of the same process is omitted.

As shown in FIG. 11, in the example 2, the supply power is directly increased to 1000% of the allowable power (S23), without turning off the supply power to the heating lamps 46. Similar to the case shown in FIG. 5, this state is maintained for the predetermined period (brief time period) T (S24). Then, in place of turning off the supply power to the heating lamps 46, the supply power is decreased at a step S25 (it is preferable that the supply power is decreased close to 0). Then, this state is maintained for the slight time period Δt (S26). Such a heat cycle is performed predetermined times (S27).

In the example 2, preferably, the power that has been decreased at the step S25 is a power smaller than the power supplied to the heating lamps 46 while the process temperature for the film deposition is being maintained (e.g. 20% to 90% is preferable). Also in the example 2, the same effect as that of the aforementioned example 1 can be produced.

In the above description, although the maximum allowable power (100%) of the heating lamps is supplied at the brief large-power supply step, the present invention is not limited thereto. Any value is available as long as the value is larger than the power supplied to the heating lamps 46 while the process temperature for the film deposition is being maintained. For example, the value may be 90% of the maximum allowable power.

In addition, in the above description, although the film deposition process of a tungsten film has been described by way of example, the present invention is not limited thereto. Even when another kind of film is deposited, the present invention may be applied.

Further, not limited to the film deposition process, the present invention may be applied to other heat processes such as an oxidation and diffusion process, an annealing process, a modification process, and an etching process.

Furthermore, not limited to a semiconductor wafer as an object to be processed, the present invention may be also applied when an LCD substrate, a glass substrate, a ceramic substrate or the like is processed.

1. A heat processing method comprising:
a placement step in which an object to be processed is placed on a stage disposed in a processing vessel whose inside atmosphere is capable of being discharged; and
a heat processing step that is performed after the placement step, in which a temperature of the object to be processed is elevated to a predetermined set temperature and is maintained thereat by a heating unit that is activated by a power supply, and in which a predetermined gas is caused to flow into the processing vessel so as to perform a predetermined heat process to the object to be processed;
wherein, immediately before the heat processing step, there is performed at least once a brief large-power supply step, in which a power larger than that to be supplied to the heating unit for maintaining the temperature of the object to be processed in the heat processing step is briefly supplied to the heating unit.

2. The heat processing method according to claim 1, wherein
as a pre-step of the brief large-power supply step, there is performed a precoating step, in which the predetermined gas is caused to flow into the processing vessel in which the object to be processed has not been received, so as to perform a precoating process to an inside of the processing vessel.

3. The heat processing method according to claim 2, wherein
as a pre-step of the precoating step, there is performed a cleaning step, in which a cleaning gas is caused to flow into the processing vessel at a temperature lower than the predetermined set temperature.

4. The heat processing method according to claim 1, wherein
immediately before the brief large-power supply step, there is performed a power OFF step, in which a power to be supplied to the heating unit is temporarily turned off.

5. The heat processing method according to claim 1, wherein
also immediately before the brief large-power supply step, a power is supplied to the heating unit.

6. The heat processing method according to claim 1, wherein
when the brief large-power supply step is performed, a gas is supplied into the processing vessel.

7. The heat processing method according to claim 1, wherein
the brief large-power supply step is intermittently performed at least three times.

8. The heat processing method according to claim 1, wherein
disposed near the stage is a clamp ring that is capable of being vertically moved in order that the clamp ring comes into contact with a peripheral portion of an object to be processed placed on the stage so as to fix the object to be processed onto the stage, and
the clamp ring is utilized in the placement step.

9. The heat processing method according to claim 1, wherein
the heating unit is a heating lamp arranged below the stage.

10. The heat processing method according to claim 1, wherein
a power supplied in the brief large-power supply step corresponds to 100% of a rated power of the heating unit.

11. A heat processing apparatus comprising:
a processing vessel whose inside atmosphere is capable of being discharged;
a stage disposed in the processing vessel, for placing thereon an object to be processed;
a gas introducing unit that introduces a predetermined gas into the processing vessel;
a heating unit that is activated by a power supply so as to heat the object to be processed; and
a control unit that controls the gas introducing unit and the power supply to the heating unit, so as to perform, to the object to be processed, a predetermined heat processing step in which a temperature of the object to be processed is elevated to a predetermined set temperature and is maintained thereat, and in which the predetermined gas is caused to flow into the processing vessel;
wherein the control unit further controls the power supply to the heating unit, so as to perform, immediately before the heat processing step, at least once a brief large-power supply step in which a power larger than that to be supplied to the heating unit for maintaining the temperature of the object to be processed in the heat processing step is briefly supplied to the heating unit.

12. The heat processing apparatus according to claim 11, wherein
disposed near the stage is a clamp ring that is capable of being vertically moved in order that the clamp ring comes into contact with a peripheral portion of an object to be processed placed on the stage so as to fix the object to be processed onto the stage.

13. The heat processing apparatus according to claim 11, wherein
the heating unit is a heating lamp arranged below the stage.

14. The heat processing apparatus according to claim 11, wherein
a power supplied in the brief large-power supply step corresponds to 100% of a rated power of the heating unit.

15. A control device that controls a heat processing apparatus comprising: a processing vessel whose inside atmosphere is capable of being discharged; a stage disposed in the processing vessel, for placing thereon an object to be processed; a gas introducing unit that introduces a predetermined gas into the processing vessel; and a heating unit that is activated by a power supply so as to heat the object to be processed; wherein
the control device is configured to control the gas introducing unit and the power supply to the heating unit, so as to perform, to the object to be processed, a predetermined heat processing step in which a temperature of the object to be processed is elevated to a predetermined set temperature and is maintained thereat, and
the control device is configured to further control the power supply to the heating unit, so as to perform, immediately before the heat processing step, at least once a brief large-power supply step in which a power larger than that to be supplied to the heating unit for maintaining the temperature of the object to be processed in the heat processing step is briefly supplied to the heating unit.

16. A storage medium storing therein a program to be read-out and executed by a computer so as to achieve the control device according to claim 15.
